(19) United States
(12) Patent Application Publication
(10) Pub. No.: US 2002/0137008 A1
(43) Pub. Date: Sep. 26, 2002

(54) Endodontic instrument

(76) Inventors: John T. McSpadden, Lookout Mountain, GA (US); Jonathan A. Barney, Newport Beach, CA (US)

Correspondence Address: LAW OFFICES OF JONATHAN A. BARNEY, ESQ., 312 SIGNAL ROAD, SUITE 200, NEWPORT BEACH, CA, 92663, US

(21) Appl. No.: 10/023,425

(22) Filed: Dec. 17, 2001

Related U.S. Application Data
(60) Provisional application No. 60/256,530, filed on Dec. 18, 2000.

(51) Int. Cl. A61C 5/02

(52) U.S. Cl. 433/102

(57) ABSTRACT

An endodontic file is provided that is fabricated from a superelastic alloy material such as an alloy of nickel, titanium and niobium. The superelastic alloy material is selected to have a relatively high loading plateau greater than about 500 MPa. Such alloy material allows the formation of precision ground flutes and cutting edges with reduced incidence of burrs, rolled metal deposits and other imperfections. Thus, the cutting edges of an endodontic file constructed in accordance with the invention are sharper and cleaner than heretofore achieved and less susceptible to wear. The resulting file is also stiffer than comparable files fabricated from conventional NiTi alloys such that improved tactile feedback and manipulation control are provided.

### RELATED APPLICATIONS

This application claims priority under 35 § 119(e) to provisional application Ser. No. 60/256,530 filed Dec. 18, 2000.

### BACKGROUND OF THE INVENTION

1. Field of the Invention

The present invention relates generally to the field of dentistry and more particularly to nickel-titanium endodontic instruments used for performing root canal therapy.

2. Description of the Related Art

In the field of endodontics, one of the most important and delicate procedures is root canal therapy or cleaning and extirpating a root canal to provide a properly dimensioned cavity to receive a biologically inert filling material such as gutta percha. This procedure is important in order to enable complete filling of the canal without any voids and in a manner which prevents the entrapment of noxious tissue in the canal as the canal is being filled.

In a typical root canal procedure, the dentist removes decayed and/or inflamed tissue and debris from the canal using an endodontic file or rasp. In performing this procedure the dentist must gain access to the entire canal, shaping it as necessary while substantially maintaining the central axis of the canal. But root canals normally are very small in diameter, and can be quite curved and/or convoluted. It is therefore often very difficult to gain access to the full length and all affected surfaces of a root canal using a conventional endodontic file.

Endodontic files have historically been made from stainless steel. These tools provide excellent manipulation control and sharp, long-lasting cutting surfaces. However, due to the inherent limited flexibility of steel, such tools can pose a significant danger of breakage, especially in sharply curved and/or heavily calcified root canals. To alleviate the breakage problem, endodontic files fabricated from nickel-titanium alloy (Nitinol™ or NiTi) have been introduced.

Nickel-titanium has several peculiar properties that make it very useful in endodontic applications. In particular, the alloy has the unusual ability to reversibly change its crystalline structure from a hard, high-modulus “austentitic” crystalline form to a soft, ductile “martensitic” crystalline form upon application of pressure and/or by cooling. This results in a highly elastic material having a very pronounced pseudo-elastic strain characteristic. This pseudo-elastic elastic strain characteristic is often described as “superelasticity.”

As a result of this reversible stress-induced crystalline transformation process a very tough and rubber-like elasticity is provided in such alloys. These material properties have proven very desirable for endodontic files in overcoming the aforementioned breakage problems. A series of comparative tests of endodontic instruments made of nickel-titanium and stainless steel were conducted and published in an article entitled “An Initial Investigation of the Bending and the Torsional Properties of Nitinol Root Canal Files,” Journal of Endodontics, Volume 14, No. 7, July 1988, pages 346-351. The Nitinol instruments involved in these tests were manufactured in accordance with fabrication procedures and operating parameters conventionally used in the machining of stainless steel endodontic instruments. This process involved grinding one or more helical flutes in a tapered shaft to form helical cutting edges. The reported tests demonstrated that the NiTi instruments exhibited superior flexibility and torsional properties as compared to stainless steel instruments.

Based on the initial success of these and other similar studies, NiTi endodontic instruments have been commercially introduced and have become widely accepted in the industry. As the use of such NiTi instruments has proliferated, however, certain drawbacks have become apparent.

One particularly well-documented drawback is the expense and difficulty of machining endodontic files from NiTi alloy. Slow grinding with fine-grit grinding wheels is the presently accepted method for machining NiTi alloys, but even then, special procedures and parameters must typically be observed to obtain reliable results. See, for example, U.S. Pat. No. 5,464,362 to Heath et. al., which describes a method of grinding a rod of a nickel-titanium alloy to create a fluted endodontic file. The cost of purchasing and operating the specialized grinding machines and grinding wheels required, and the relatively slow grinding process make the endodontic files produced by this method inordinately expensive when compared to their stainless steel counterparts.

Another significant drawback is the tendency of the NiTi material to form latent burrs, rolled metal deposits and/or other imperfections along the desired cutting edges during the machining process. If these imperfections are not carefully monitored and controlled, they can have deleterious effects on file performance. Another significant drawback is that the cutting edges of presently available NiTi instruments are not as sharp as their stainless steel counterparts and tend to lose their sharpness more rapidly with use. Another significant drawback is reduced manipulation control due to reduced stiffness and extreme torsional flexibility of presently available NiTi endodontic files as compared with stainless steel files.

These and other drawbacks have created a demand for improved NiTi alloys, machining methods and instruments fabricated therefrom that overcome the aforenoted drawbacks while preserving the essential advantages of the nickel-titanium alloy.

### SUMMARY OF THE INVENTION

It is therefore an object of the present invention to provide an improved class of superelastic alloy materials particularly adapted for use in endodontic files. It is another object of the invention to provide an endodontic instrument having improved manipulation control, sharp cutting edges and a reduced tendency to break during use. It is another object of the invention to reduce the number of instruments necessary to enlarge a root canal. Still another object of the invention is to provide an endodontic instrument which can be more quickly and economically produced.

In one preferred embodiment, the invention provides an endodontic file fabricated from a superelastic alloy material comprising nickel-titanium. The superelastic alloy material is selected to have a relatively high loading plateau greater than about 500 MPa. Such alloy material allows the formation of precision ground flutes and cutting edges with a reduced incidence of burrs, rolled metal deposits and other imperfections. Thus, the cutting edges of an endodontic file constructed in accordance with the invention are sharper and cleaner than heretofore achieved and less susceptible to wear. The resulting file is also stiffer and more responsive than comparable files fabricated from conventional NiTi alloys such that improved tactile feedback and manipulation control are provided.

In another preferred embodiment, the invention provides an endodontic file fabricated from a superelastic alloy material, such as nickel-titanium, that has significant latent stress and crystalline deformation induced by cold working. Such alloy material is generally harder and stiffer than conventional NiTi alloys used for endodontic files. Therefore, such improved alloy allows the formation of precision ground flutes and cutting edges with a reduced incidence of burrs, rolled metal deposits and other imperfections. The cutting edges of an endodontic file constructed in accordance with the invention are sharper and cleaner than heretofore achieved and less susceptible to wear. The resulting file is also stiffer and more responsive than comparable files fabricated from conventional NiTi alloys such that improved tactile feedback and manipulation control are provided.

In another preferred embodiment, the invention provides an endodontic file fabricated from a superelastic alloy material comprising nickel, titanium and at least 5% niobium by weight. Such alloy material is generally harder and stiffer than conventional NiTi alloys used for endodontic files. Therefore, such improved alloy allows the formation of precision ground flutes and cutting edges with a reduced incidence of burrs, rolled metal deposits and other imperfections. Thus, the cutting edges of an endodontic file constructed in accordance with the invention are sharper and cleaner than heretofore achieved and less susceptible to wear. The resulting file is also stiffer than comparable files fabricated from conventional NiTi alloys such that improved tactile feedback and manipulation control are provided.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Having thus summarized the general nature of the invention and its essential features and advantages, certain preferred embodiments and modifications thereof will become apparent to those skilled in the art from the detailed description herein having reference to the figures that follow, of which:

FIG. 1 is a section view of a tooth and associated root structure illustrating the use of an endodontic file for performing a typical root canal procedure;

FIGS. 2A-H are various views illustrating a typical prior art fluted endodontic file fabricated from a nickel titanium alloy;

FIG. 3A is a comparative stress-strain diagram of various nickel-titanium alloys versus stainless steel;

FIG. 3B is a comparative energy-absorption or toughness diagram of various nickel-titanium alloys versus stainless steel;

FIGS. 4A-H are various views of one preferred embodiment of a fluted endodontic file having features and advantages in accordance with the present invention;

FIGS. 5A-H are various views of a first alternative preferred embodiment of a fluted endodontic file having features and advantages in accordance with the present invention; and

FIGS. 6A-H are various views of a second alternative preferred embodiment of a fluted endodontic file having features and advantages in accordance with the present invention.

### DESCRIPTION OF THE PREFERRED EMBODIMENTS

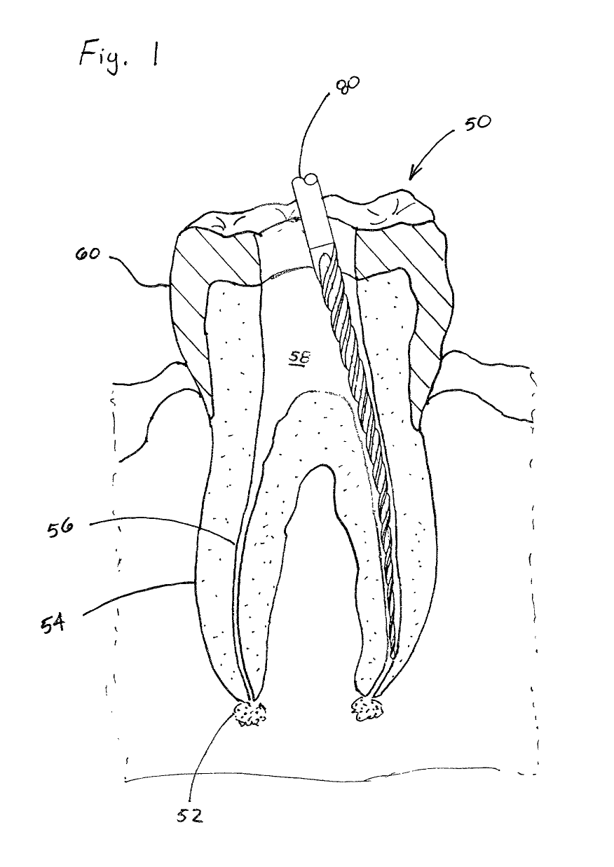

FIG. 1 is a partial cross section of a tooth 50 and supporting root structure illustrating the use of an endodontic file 80 to carry out a standard root canal procedure. The root canal 56 of a tooth houses the circulatory and neural systems of the tooth. These enter the tooth at the terminus 52 of each of its roots 54 and extend through a narrow, tapered canal system to a pulp chamber 58 adjacent the crown portion 60 of the tooth. If this pulp tissue becomes diseased or injured, it can cause severe pain and trauma to the tooth, sometimes necessitating extraction of the tooth. Root canal therapy involves removing the diseased tissue from the canal 56 and sealing the canal system in its entirety. If successful, root canal therapy can effectively alleviate the pain and trauma associated with the tooth so that it need not be extracted.

To perform a root canal procedure, the endodontist first drills into the tooth 50 to locate the root canal(s) 56 and then uses an endodontic file or reamer instrument 80 to remove the decayed, injured or dead tissue from the canal. These instruments are typically elongated cutting or abrading instruments which are rotated and/or reciprocated within the root canal either by hand or using a slow speed drill. The primary goal is to remove all of the decayed or injured nerve while leaving the integrity of the root canal walls relatively unaffected. Preserving the integrity of the root canal 56 is important in order to allow proper filling of the root canal void in a homogenous three dimensional manner such that leakage or communication between the root canal system and the surrounding and supporting tissues of the tooth 50 is prevented. Once as much of the diseased material as practicable is removed from the root canal, the canal 56 is sealed closed, typically by reciprocating and/or rotating a condenser instrument in the canal to urge a sealing material such as gutta-percha into the canal.

One of the primary challenges in performing root canal therapy is that the root canals are not necessarily straight and are often curved or convoluted. Therefore, it is often difficult to clean the canal while preserving its natural shape. Many instruments (particularly the older, stainless steel instruments) have a tendency to straighten out the canal or to proceed straight into the root canal wall, altering the natural shape of the canal. In some extreme cases, the instrument may transport completely through the canal wall causing additional trauma to the tooth and/or surrounding tissues. Also, the openings of many root canals are small, particularly in older patients, due to calcified deposits on the root canal inner walls. Thus the files or reamers must be able to withstand the torsional load necessary to penetrate and enlarge the canal opening without breaking the instrument, as may also occasionally occur with the older stainless steel endodontic files.

To alleviate the transportation and breakage problems, highly flexible endodontic files fabricated from nickel-titanium alloy (Nitinol™ or NiTi) were introduced and have become the preferred choice for many experienced endodontists. However, as the acceptance and use of such NiTi instruments have proliferated certain drawbacks have become apparent, as will be addressed herein.

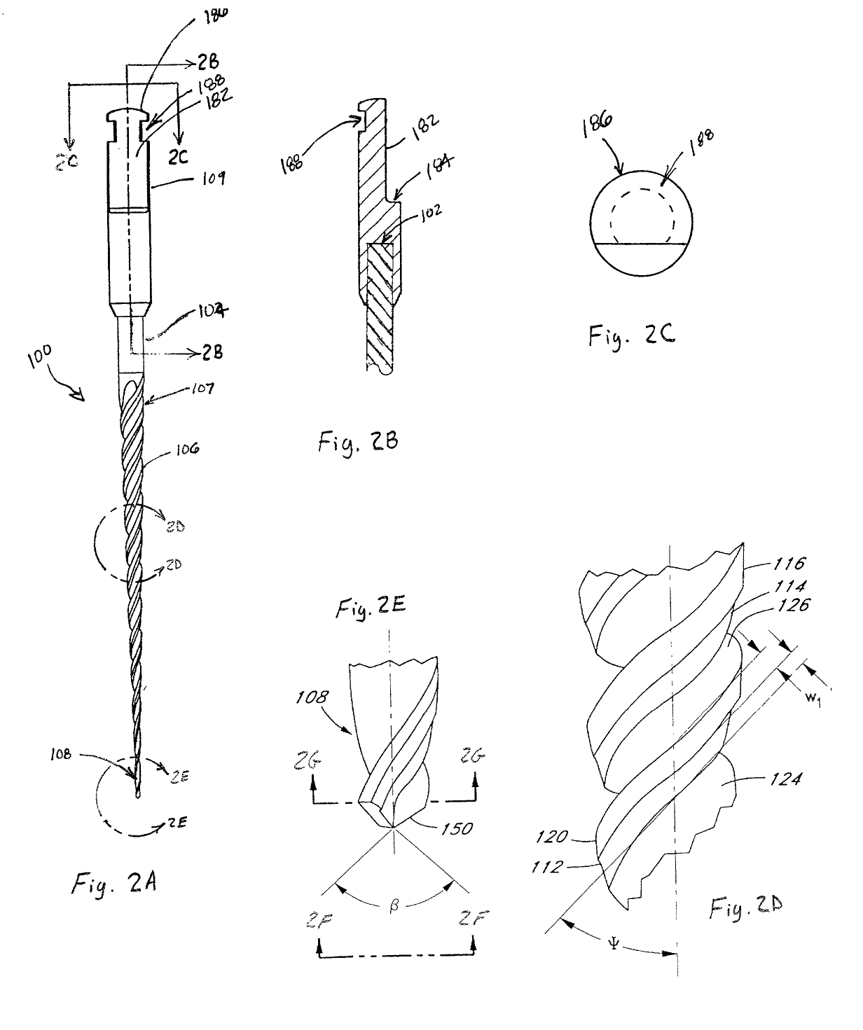

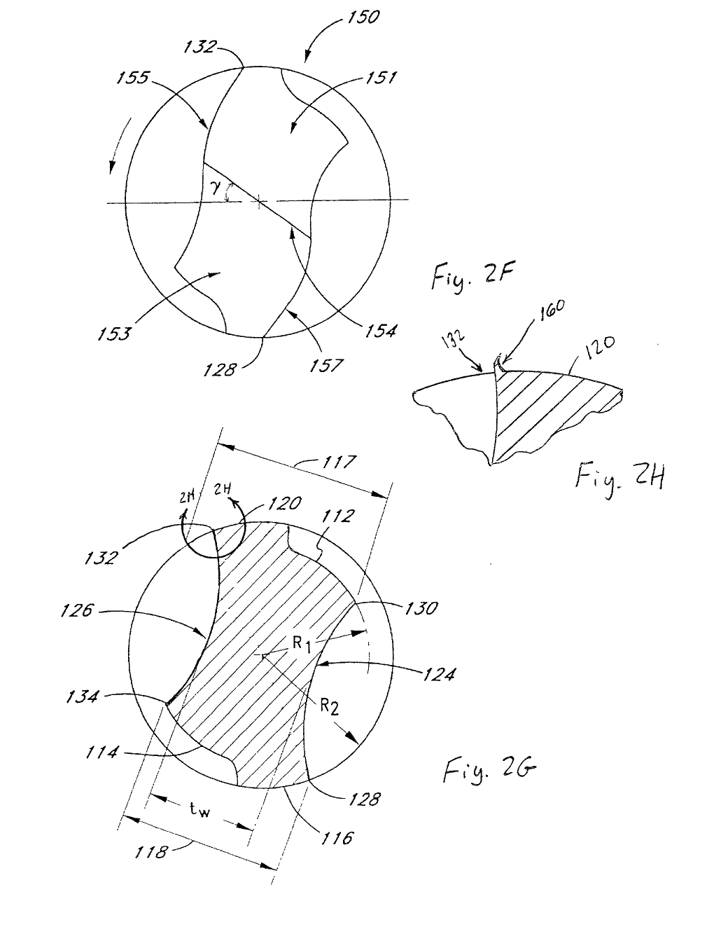

FIGS. 2A-H are various views of a typical fluted endodontic file fabricated from a NiTi alloy. See, e.g. U.S. Pat. No. 5,882,198, incorporated herein by reference. The file 100 generally comprises a shaft 102 having a shank portion 104 and an elongated working portion 106. The working portion 106 extends from a proximal end 107 adjacent the base of the shank 104 to a distal end 108 terminating in a chisel tip 150. The shank portion 104 may typically include a fitting portion 109 for mating with the chuck of a dental handpiece (not shown). The fitting portion 109 includes a generally I-shaped flat side 182 which defines a step 184 and a generally semicircular disk 186 above and adjacent to a generally semi-circular groove 188. Such fitting 109 is typical of those employed in the dental industry for connecting or interfacing a dental tool with dental drill or handpiece.

Alternatively and/or in addition to the fitting portion 109, the shank portion 104 may include a knurled or otherwise treated surface (not shown) or handle to facilitate hand manipulation of the file 100. Thus, the instrument 100 may either be used by manipulating the instrument manually in a rotating or reciprocating action, or the instrument may be manipulated by attaching the fitting portion 109 of the instrument to a motorized handpiece for effecting more rapid removal of tissue from the root canal, as desired.

Helical flutes 124 and 126 are formed in the working portion 106 extending from the distal end 108 adjacent the tip 150 and exiting at the proximal end 107 (sometimes called the “flute exit” or “exit”), as shown in FIG. 2A. These flutes are typically formed by specialized slow-speed grinding operations using a 3-axis or 6-axis grinding machine in accordance with well-documented manufacturing techniques. Any number of such flutes may be formed in this manner, as desired.

Helical lands 116 and 118 are typically provided generally extending between adjacent flutes 124 and 126. The helical flutes 124, 126 and helical lands 116, 118 intersect one another to define leading edges 128, 132 and trailing edges 130, 134 with respect to clockwise rotation of the instrument (see, e.g. FIG. 2G). The leading edges 124, 126 are typically sharpened to provide a cutting edge for removing tissue from the root canal as the instrument is rotated and/or reciprocated. The trailing edges 130, 134 may be sharpened or not, depending upon the particular file geometries desired and manufacturing conveniences. Rake angles of the cutting edges 128, 132 may be positive, negative, or neutral, depending upon manufacturing convenience and/or clinical purpose. Typical rake angles range from about +20 degrees to about −35 degrees measured with respect to a radial line passing through the cutting edge perpendicular to a line tangent to the periphery of the working portion.

As shown in FIGS. 2D and 2G the helical lands 117, 118 are typically formed so as to define outer peripheral land portions 116, 120 having width w₁ (sometimes called the “margin width”) and optional recessed land portions 112, 114 having width w₂ (sometimes called the “relief width”). The combined width w₁+w₂ is sometimes called the “land width.” The recessed land portions 112, 114 are at a first predetermined radial distance R₁ from the cross-sectional center of the working portion 106. The outer land portions 116, 120 lie at the outer periphery of the working portion 106 at a second predetermined radial distance R₂ from the center of the working portion 106, typically about 4 to 30 percent greater than the radial distance R₁.

The working portion 106 of the instrument 100 typically has a length ranging from about 3 mm to about 18 mm. A commonly preferred length is about 16 mm. The working portion 106 may have a constant cross-sectional diameter or, more typically, it is tapered from the proximal end 107 to the distal end 108, as shown. In the particular embodiment shown, the taper is substantially uniform—that is, the rate of taper is constant along the working portion 106. A typical taper rate may range from about 0.01 mm/mm to about 0.08 mm/mm. The web thickness “t_{w}”—that is the thickness of the “web” of material between opposed flutes 124, 126—is also typically tapered from the proximal end 107 of the working portion to the distal end 108. The web taper rate is typically between about −0.01 mm/mm to about 0.08 mm/mm.

The tip 150 of the instrument 100 may assume any number of a variety of possible configurations, depending upon the preference of the endodontist and manufacturing conveniences. In the illustrated embodiment, the tip 150 is formed as a chisel edge or chisel tip, as shown in more detail in FIGS. 2E and 2F. The chisel tip 150 generally comprises two or more facets 151, 153 which intersect to define a chisel edge 154. The chisel edge 154 is typically substantially linear and substantially orthogonal to a longitudinal axis of the working portion 106, although such configuration is not necessary. Additional sharpened cutting edges 155, 157 are formed at the tip 150 by the intersection of the facets 151, 153 with the flutes 124, 126. Upon rotation of the instrument in a root canal the chisel edge 154 loosens diseased or decayed tissue while the cutting edges 155, 157 cut away and remove the tissue as the file is operated in the canal.

The chisel tip 150 is typically formed by grinding flats or facets 151, 153 into the tip of the instrument 100, as shown, forming the chisel edge 154. The facets 151, 153 define an included point angle β typically between about 45-100 degrees, as shown in FIG. 2E. The chisel edge 154 is typically canted from center by a primary angle γ of between about 5-25 degrees, as shown in FIG. 2F. As illustrated, The facets 151, 153 of the chisel tip 150 formed apices with the cutting edges 128, 132 and additional cutting edges 155, 157.

The endodontic instrument shown and described in connection with FIG. 2 above is made from a superelastic alloy, such as SE508 nickel-titanium wire manufactured by Nitinol Devices and Components, Inc. of Fremont, Calif. This is a typical binary nickel-titanium alloy used for endodontic files and comprises about 56% nickel and about 44% titanium by weight. Table 1, below, summarizes certain selected material properties of the SE508 NiTi alloy:

TABLE 1
SE508 MATERIAL PROPERTIES

| | |
|---|---|
| PHYSICAL PROPERTIES | |
| Melting Point | 1310° C. |
| Density | 6.5 g/cm3 |
| Electrical Resistivity | 82 μohm-cm |
| Modulus of Elasticity | 75 × 10\hat{ }6 MPa |
| Coefficient of Thermal Expansion | 11 × 10-6/° C. |
| MECHANICAL PROPERTIES | |
| Ultimate Tensile Strength (UTS) | 1150 MPa |
| Total Elongation | 10% |
| SUPERELASTIC PROPERTIES | |
| Loading Plateau Stress @ 3% strain | 450 MPa |
| Superelastic Strain (max) | 8% |
| Permanent Set (after 6% strain) | 0.2% |
| Transformation Temperature (Af) | 5-18° C. |
| COMPOSITION | |
| Nickel (nominal) | 55.8 wt. % |
| Titanium (nominal) | 44.2 wt. % |
| Oxygen (max) | 0.05 wt. % (max) |
| Carbon (max) | 0.02 wt. % (max) |

Fluted endodontic instruments fabricated from NiTi SE508 and similar NiTi alloys have been commercially introduced and have become widely accepted in the industry. As the use of such NiTi instruments has proliferated, however, certain drawbacks have become apparent.

As noted above, one particularly well-documented drawback is the expense and difficulty of machining endodontic files from such NiTi alloys. SE508 NiTi alloy, for example, is a very difficult material to process using conventional machining operations. Therefore, slow and expensive grinding operations must typically be used to create the desired fluting and cutting edges.

Another significant drawback is the tendency of the SE508 NiTi alloy and similar alloys to form latent burrs, rolled metal deposits and/or other imperfections along the desired cutting edges during the machining process. This is illustrated in more detail in FIG. 2H. Notably, it may be seen that a burr or rolled metal deposit 160 (not necessarily drawn to scale) extends outward from the cutting edge 132. If such burrs or other similarly occurring imperfections are not carefully monitored and controlled, they can have deleterious effects on file performance. Another significant drawback is that the cutting edges of presently available NiTi instruments are typically not as sharp as their stainless steel counterparts and tend to lose their sharpness more rapidly with use. Another significant drawback is reduced manipulation control due to reduced stiffness and extreme torsional flexibility of presently available NiTi endodontic files as compared with stainless steel files.

The present invention provides an improved class of superelastic alloys and manufacturing techniques particularly suited and adapted for forming endodontic files and which overcome the aforenoted drawbacks while preserving and enhancing the essential advantages of the superelastic alloy in minimizing file breakage and canal wall transportation. In particular, it has been discovered that by increasing the loading plateau of a superelastic alloy, its machinability, cutting-edge sharpness and sharpness holding-ability, and manipulation control are improved resulting in increased clinical efficacy and manufacturing economy.

The concepts and teachings of the present invention are particularly applicable to nickel-titanium alloys and endodontic instruments (files, reamers, obturators, drill bits and the like) fabricated therefrom. However, the invention disclosed herein is not limited specifically to endodontic instruments fabricated from NiTi alloys, but may be practiced with a variety of dental instruments using any one of a number of other suitable alloy materials having the desired superelastic properties, such as Silver-Cadmium (Ag—Cd), Gold-Cadmium (Au—Cd) and Iron-Platinum (Fe3Pt), to name but a few.

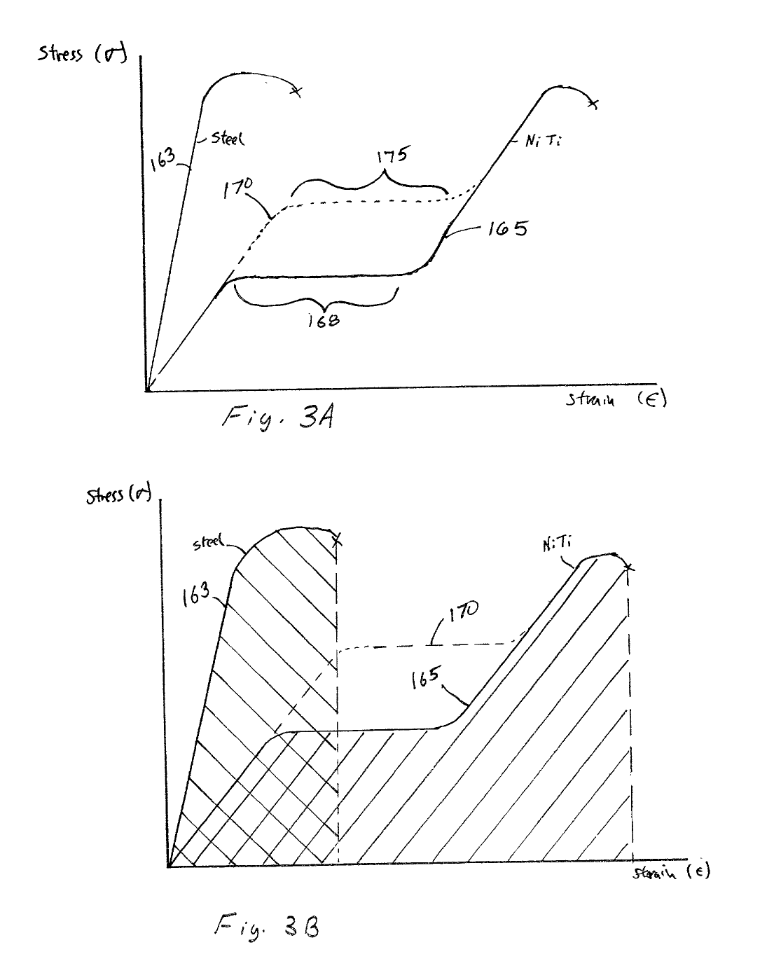

FIGS. 3A and 3B are comparative graphs illustrating stress-strain curves and energy absorption/toughness for selected NiTi alloys as compared to traditional stainless steel material. FIG. 3A shows a typical stress-strain curve 163 for stainless steel as compared to similar curves 165, 170 for selected NiTi alloys. As can be discerned from the graph, each of the NiTi alloys has a significantly larger strain to failure than stainless steel. This is largely because the NiTi alloys exhibit a superelastic property that enable them to undergo significant strain at a substantially constant stress or load level, sometimes called the “loading plateau” 168, 175.

Curve 165 indicates a stress-strain curve and loading plateau 168 for a typical NiTi alloy, such as SE508, used to fabricate endodontic files. Curve 170 indicates a stress-strain curve and loading plateau 175 for an improved class of superelastic alloys having features and advantages in accordance with the present invention. In particular, those skilled in the art will recognize that the curve 170 indicates a higher loading plateau 175 than the loading plateau 168 of curve 165.

The increased loading plateau 175 is desirable for several reasons. For a given file design and diameter, a higher loading plateau increases the apparent stiffness of the file (in both bending and torsion) and therefore its responsiveness and ease of manipulation by endodontists. Files formed from conventional NiTi alloys can often feel overly flexible and non-responsive and, thus, exhibit reduced tactile feedback and difficult manipulation control—particularly in the smaller diameter files. Endodontic files fabricated from improved superelastic alloys having increased stiffness in accordance with one preferred embodiment of the invention provide improved responsiveness and manipulation control without significantly adversely increasing the risk of file breakage or canal wall transportation.

A higher loading plateau can, in some alloys, also increase the toughness or amount of energy required to permanently deform or break the file. FIG. 3B shows a typical toughness or energy absorption characteristic for stainless steel (area under curve 163) as compared to the toughness of a typical NiTi alloy used for endodontic files (area under curve 165). As can be discerned from the graph, NiTi is a tougher material than stainless steel as it absorbs more energy before ultimately failing. Curve 170 indicates a stress-strain curve for an improved class of NiTi alloys having features and advantages in accordance with the present invention. Those skilled in the art will recognize that the area under curve 170 is larger than the area under curve 165. Therefore, it is anticipated that endodontic files fabricated from such alloy may exhibit improved toughness and resistance to breakage. Of course, it is not required that this relationship hold true in all cases, as it is contemplated that suitable superelastic alloys having some or all of the advantages disclosed herein may still be clinically advantageous for use in endodontic files, albeit possibly not quite as tough as present NiTi alloys.

There are several ways in which an improved superelastic alloy may be realized. One way is by cold working a superelastic material, such as conventional NiTi alloy, by drawing or rolling it. Conventional NiTi alloys for endodontic file use, such as SE508 NiTi, are drawn down in wire form from larger diameter wire to smaller and smaller diameter wire as dictated by the particular instrument size desired to be achieved. Typically this is done without the application of heat and, thus, the material undergoes “cold-working” or permanent deformation of the material crystalline structure. Cold-working increases the mechanical characteristics of the alloy and produces a concomitant rise in the loading plateau and the apparent stiffness/hardness of the material itself.

In the conventional manufacturing process, however, the drawn NiTi wire material is first heat treated and fully annealed to relieve most if not all of the latent stress and crystalline deformation in the material and to set a permanent straightened shape to the wire prior to machining. Such heat treatment and annealing is typically required to optimize the material's superalasticity and other desired properties. Once heat treating and annealing are completed, the wire is machined to its final form using various grinding operations to form the desired instrument shape, fluting and cutting edges.

Surprisingly, it has been discovered that a certain amount of residual cold working of the NiTi alloy is desirable and can actually improve the machining characteristics of the material, making it easier and less expensive to form an endodontic file of a desired configuration using either grinding or conventional machining techniques. Because the alloy in its cold-worked state is harder than when fully annealed, it is capable of having cutting edges sharpened to a higher degree and with higher durability and wear resistance than with a conventional heat-annealed or non-cold-worked NiTi alloy. It is anticipated that any amount of cold working over about 2-3% will produce advantageous results. Cold working between about 5-45% is preferred, with about 10-18% being more preferred and about 12-15% being most preferred. If desired, the formed endodontic file (i.e., subsequent to machining) may be further heat treated and/or annealed in order to achieve the desired degree of superelasticity or other material properties and/or to set a desired file shape (straight, pre-curved or pre-twisted).

Another preferred technique to achieve an improved superelastic alloy (e.g. NiTi) for forming endodontic files is by special annealing processes, heat treatments and/or by varying the alloy composition or adding of trace elements, such as oxygen (O), nitrogen (N), iron (Fe), aluminum (Al), chromium (Cr), cobalt (Co) vanadium (V), zirconium (Zr) and copper (Cu). See, for example, U.S. Pat. No. 5,843,244 to Pelton, incorporated herein by reference. An alloy formed from a combination of nickel, titanium and niobium has been found to have particular advantage for use in endodontic files. Suitable NiTi alloys having niobium present in the amounts of 5-30%, more preferably, 8-20%, and most preferably 12-14% by weight, are contemplated. One preferred alloy is available, for example, from Memry Corporation of Menlo Park Calif. under the name Alloy “X”. This particular alloy exhibits a relatively high loading plateau of about 870 MPa—nearly twice that of SE508 NiTi. As a practical regime, suitable superelastic alloys having loading plateaus greater than about 500 MPa, more preferably greater than about 750 MPa, and most preferably greater than about 850 MPa may be used with efficacy. Of course, various combinations and compositions are also possible. It is also not required that the loading plateau be perfectly flat or level or as promounced, so long as adequate flexibility and material toughness are provided given the desired application.

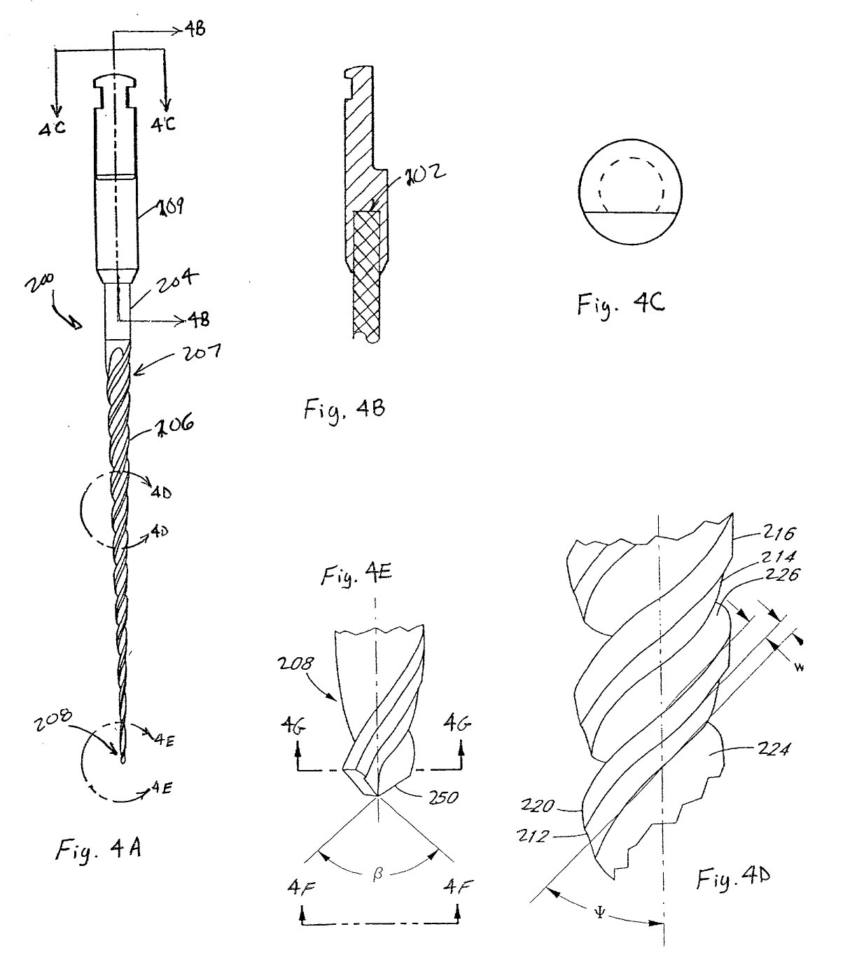

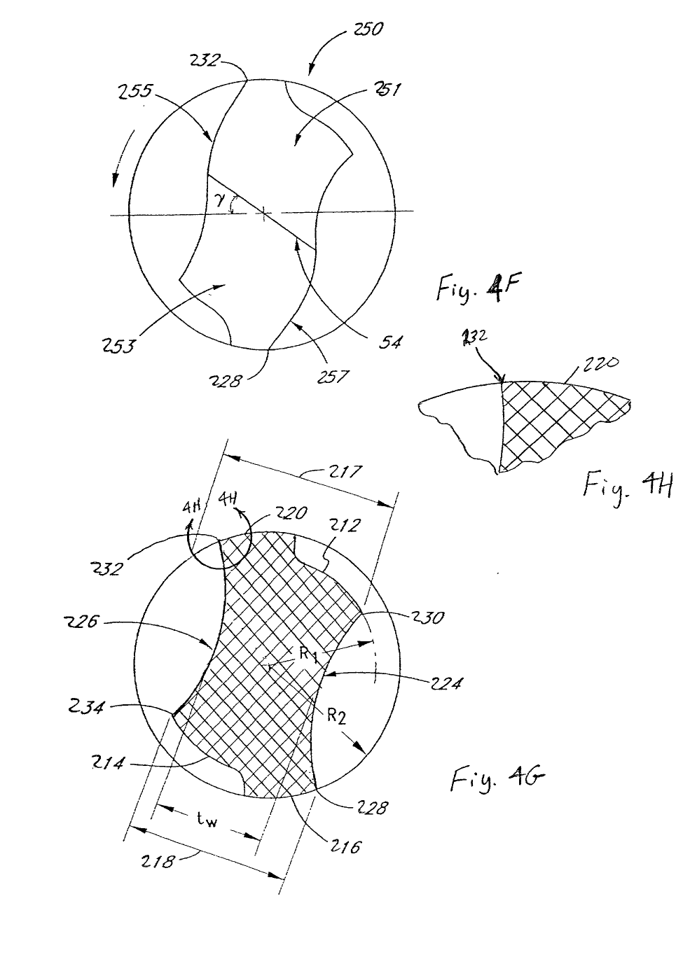

FIGS. 4A-H are various views of one embodiment of a fluted endodontic file 200 fabricated from an improved NiTi superelastic alloy and having features and advantages in accordance with the invention. For convenience and brevity of description elements similar to those described above in connection with FIGS. 2A-H are denoted using like reference numerals and the description thereof will not be repeated.

File 200 is fabricated from a tapered or untapered rod comprising an alloy of nickel, titanium and niobium. One such preferred alloy is available from Memry Corporation of Menlo Park Calif. under the name Alloy “X”. Advantageously, NiTi Alloy X is stiffer and has a higher loading plateau than conventional NiTi alloys heretofore used for endodontic files. Thus, it allows the formation of ground flutes and cutting edges with higher precision and with reduced incidence of burrs, rolled metal deposits and other imperfections. Thus, the cutting edges 232, 228 of the file 200 are sharper and cleaner than heretofore achieved (see, FIG. 4H). Moreover, because the improved NiTi alloy is stiffer/harder than conventional NiTi alloys, the cutting edges 228, 232 are capable of being sharpened to a higher degree and of being more durable than heretofore possible. Increased stiffness also improves tactile feedback and manipulation control. Thus, an endodontic file 200 having desirable superelastic properties is provided without the aforenoted drawbacks typically associated with nickel-titanium files. If desired, the resulting machined endodontic file may be subjected to further heat treatment and/or annealing processes in order to achieve greater flexibility, superelasticity and/or other desired properties.

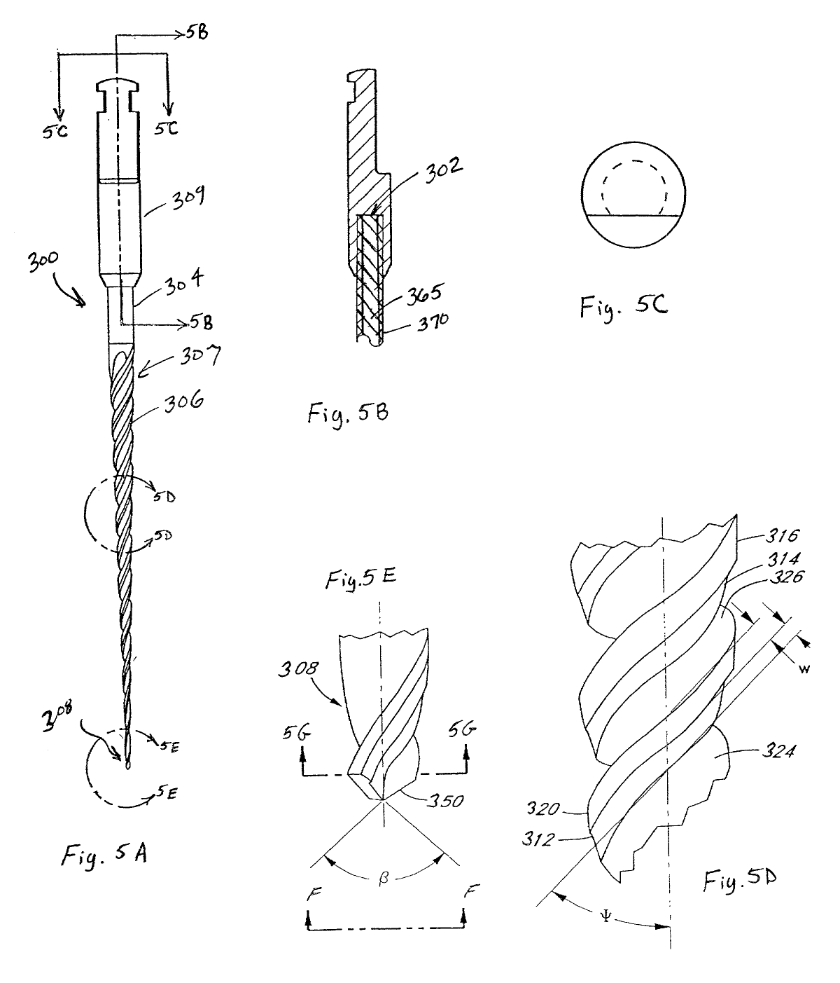

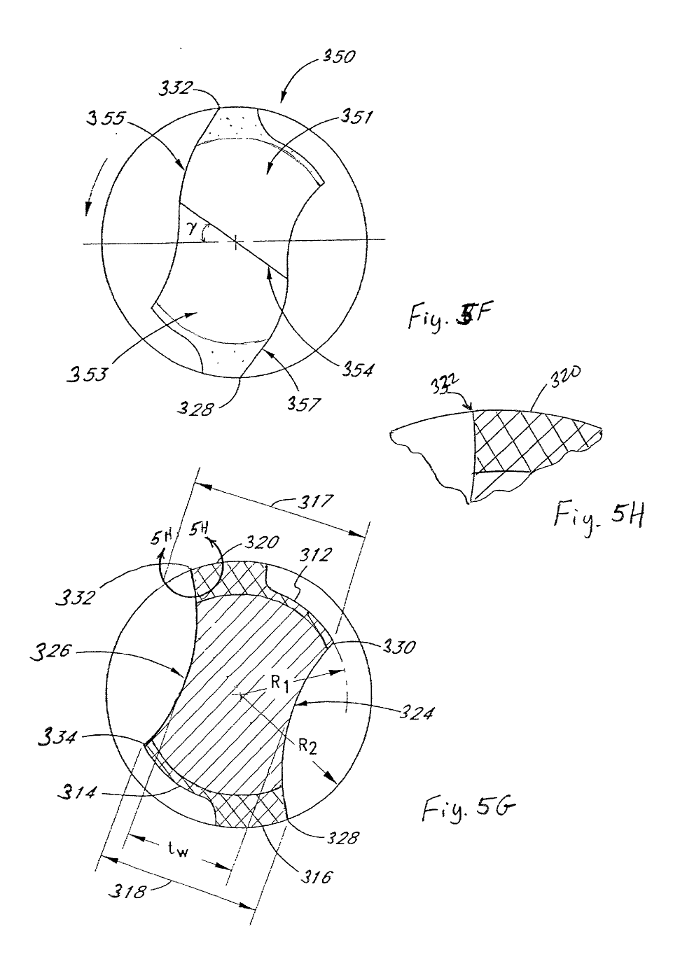

FIGS. 5A-H are various views of an alternative preferred embodiment of a fluted endodontic file 300 having features and advantages in accordance with the present invention. For convenience and brevity of description elements similar to those described above are denoted using like reference numerals and the description thereof will not be repeated.

File 300 is fabricated from a tapered or untapered rod comprising a core 365 of superelastic alloy material, such as NiTi alloy, and an outer sheath formed of another material such as stainless steel or a second, preferably relatively hard NiTi alloy such as an alloy of nickel, titanium and niobium (e.g., Alloy “X”). Advantageously, the superelastic material comprising core 365 provides desired toughness and resilience against breakage, while the harder outer sheath material 370 provides good machinability, sharpness and durability. An outer sheath 370 formed from stainless steel tubing reduced around and/or co-drawn with a NiTi inner core 365 (e.g., Alloy X or SE508) allows advantageous formation of a NiTi endodontic file with precision ground flutes and cutting edges having reduced incidence of burrs, rolled metal deposits and other imperfections (see, FIG. 5H). Thus, the cutting edges 332, 328 of the file 300 are sharper and cleaner than heretofore achieved and are capable of being sharpened to a higher degree and are more durable and resistance to wear than heretofore possible. If desired, the inner core 370 may comprise a superelastic alloy having increased stiffness (e.g., Alloy X) so as to provide improved responsiveness and manipulation control. Thus, an endodontic file 300 having desirable superelastic properties is provided without the aforenoted drawbacks typically associated with nickel-titanium files.

As a variation on the above alternative embodiment, the file 300 may alternatively be fabricated from a tapered or untapered rod comprising a superelastic alloy material, such as NiTi alloy (e.g., Alloy X or SE508) , that has been subjected to significant cold-working (preferably about 30-45%) and selectively heat treated and/or annealed to form a substantially recrystallized inner core 365 and a substantially non-recrystallized outer jacket 370. Preferably the treatment process is selectively applied or otherwise conducted in a manner that significantly anneals and releases latent crystalline deformation within the central portion or core area 365 but does not significantly anneal and release latent crystalline deformation within the surrounding jacket of material 370 immediately adjacent the outer surface. In this manner, the outer portion 370 of the file 300 and particularly the cutting edges 328, 332 thereof may be rendered harder and more durable and resistant to wear than the inner portion 365, without compromising overall flexibility and resistance to breakage of the file 300.

Preferably, selective heat treatment and/or annealing may be accomplished by passing an electrical current through a length of cold-worked NiTi wire either in a cool air environment, inert gas or liquid annealing fluid, such as water, oil or the like. In this manner, the wire is internally heated (due to its own electrical resistance) while being maintained relatively cool externally due to convective heat exchange with a surrounding cool air/gas environment or other annealing fluid.

The relatively hard, cold-worked NiTi material in region 370 allows advantageous formation of precision ground flutes and cutting edges having reduced incidence of burrs, rolled metal deposits and other imperfections. Thus, the cutting edges 332, 328 of the modified file 300 are sharper and cleaner than heretofore achieved and are capable of being sharpened to a higher degree and of being more durable and resistant to wear than heretofore possible. If desired, the resulting machined endodontic file may be subjected to further post-machining heat treatment and/or annealing processes in order to achieve greater flexibility, superelasticity and/or other desired properties.

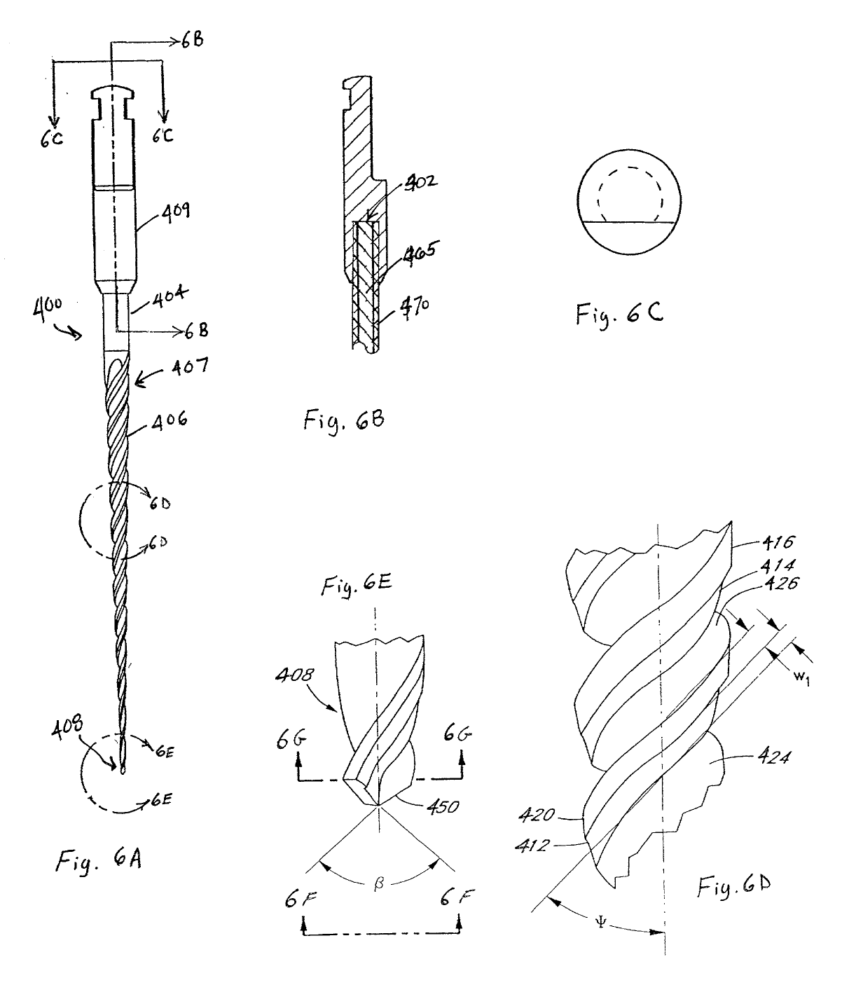

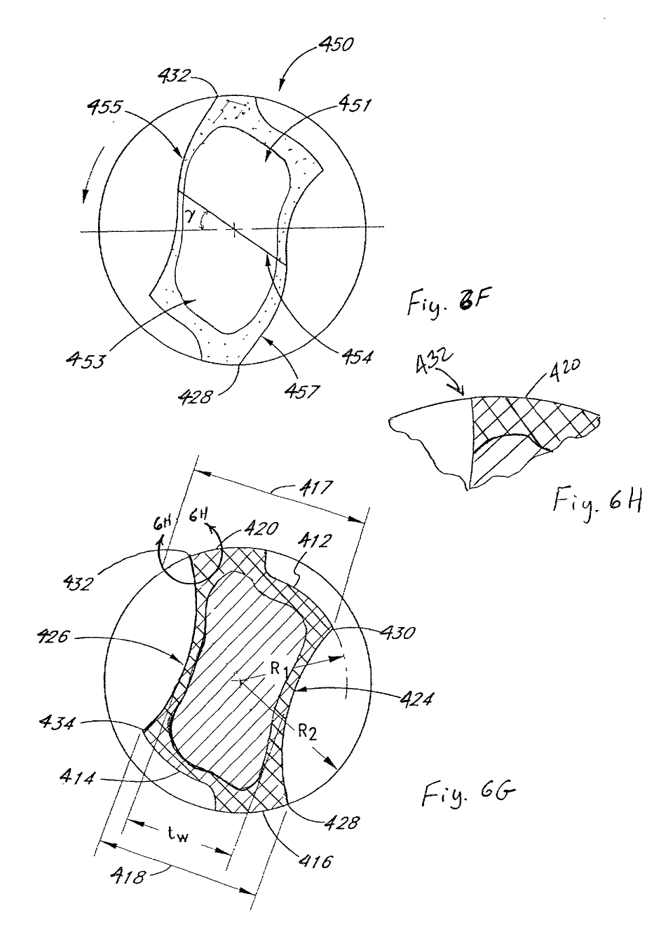

FIGS. 6A-H are various views of a further alternative preferred embodiment of a fluted endodontic file 400 having features and advantages in accordance with the invention. For convenience and brevity of description elements similar to those described above are denoted using like reference numerals and the description thereof will not be repeated.

File 400 is fabricated from a tapered or untapered rod comprising a superelastic alloy material, such as NiTi alloy, that has been subjected to significant cold-working (preferably about 30-45%) and has significant latent cold-worked crystalline deformation prior to machining. The cold-worked NiTi material (e.g., Alloy X or SE508) allows advantageous formation of a NiTi endodontic file with precision ground flutes and cutting edges having reduced incidence of burrs, rolled metal deposits and other imperfections (see, FIG. 6H). Thus, the cutting edges 432, 428 of the file 400 are sharper and cleaner than heretofore achieved and are capable of being sharpened to a higher degree and of being more durable and resistant to wear than heretofore possible.

Following machining, the endodontic file 400 is preferably subjected to further heat treatment and/or annealing processes in order to achieve greater flexibility, superelasticity and/or other desired properties. More preferably, such further heat treatment and/or annealing is selectively applied or otherwise conducted in a manner that significantly anneals and releases latent crystalline deformation within the central or core area 465 but does not significantly anneal and release latent crystalline deformation within the surrounding jacket of material 470 immediately adjacent the outer surface thereof. In this manner, the outer portion 470 of the file 400 and particularly the cutting edges 428, 432 thereof may be rendered harder and more durable than the inner portion 465, without compromising overall flexibility and resistance to breakage of the file 400.

Such selective heat treatment and/or annealing may be accomplished, for example, by passing an electrical current through the machined NiTi file wire in a cool air environment, inert gas or liquid annealing fluid, such as water, oil or the like. In this manner, the file is internally heated (due to its own electrical resistance) while being cooled externally by convective heat exchange with a surrounding cool air/gas environment or other annealing fluid.

Advantageously, the superelastic material comprising core 465 provides desired toughness and resilience against breakage, while the harder outer material 470 provides good machinability, sharpness, durability and resistance to wear. Thus, an endodontic file 400 having desirable superelastic properties is provided without the aforenoted drawbacks typically associated with nickel-titanium files. If desired, the resulting machined endodontic file may be subjected to further (and/or alternative) heat treatment or annealing processes in order to achieve greater flexibility, superelasticity and/or other desired properties.

While the aforedescribed endodontic files 200, 300, 400 are of a tapered, fluted design, those skilled in the art will recognize that the concepts and teachings herein may be applied with equal efficacy to a wide variety of other endodontic file designs (e.g., hedstrom, K-file, rasp, abrasion, etc.). Those skilled in the art will also recognize that a variety of well known machining techniques for making conventional endodontic instruments may also generally be applied to the manufacture of instruments as disclosed herein with various known or later developed improvements in materials or processing. For example, suitable instruments may be ground from a straight or tapered rod, twisted, and/or drawn to a taper with or without grinding. Suitable grinding techniques include those described in standard metallurgical texts for grinding various metals. Those skilled in the art will further appreciate that while the particular instruments illustrated and described herein are reamers or files, similar instruments can also be configured for use as condensers or compactors by reversing the direction of twist of the helical flutes and lands and/or reversing the direction of rotation of the instrument.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

What is claimed is:

1. An endodontic instrument fabricated from an alloy of nickel and titanium wherein the nickel titanium alloy is selected to have a loading plateau greater than about 500 MPa.

2. The endodontic instrument of claim 1 wherein the nickel titanium alloy is selected to have a loading plateau greater than about 750 MPa.

3. The endodontic instrument of claim 1 wherein the nickel titanium alloy is selected to have a loading plateau greater than about 850 MPa.

4. The endodontic instrument of claim 1 wherein the instrument comprises a fluted endodontic file having one or more flutes defining one or more corresponding cutting edges.

5. An endodontic instrument fabricated from an alloy of nickel, titanium and at least 5% niobium by weight.

6. The endodontic instrument of claim 5 wherein the alloy of nickel, titanium and niobium comprises between about 5-30% niobium by weight.

7. The endodontic instrument of claim 5 wherein the alloy of nickel, titanium and niobium comprises between about 8-20% niobium by weight.

8. The endodontic instrument of claim 5 wherein the alloy of nickel, titanium and niobium comprises between about 12-14% niobium by weight.

9. The endodontic instrument of claim 5 wherein the instrument comprises a fluted endodontic file having one or more flutes defining one or more corresponding cutting edges.

10. An endodontic instrument machined from an alloy of nickel and titanium wherein the nickel titanium alloy comprises significant latent stress induced by cold working.

11. The endodontic instrument of claim 10 wherein the alloy of nickel and titanium comprises between about 5-45% latent stress induced by cold working.

12. The endodontic instrument of claim 10 wherein the alloy of nickel and titanium comprises between about 10-18% latent stress induced by cold working.

13. The endodontic instrument of claim 10 wherein the alloy of nickel and titanium comprises between about 12-15% latent stress induced by cold working.

14. The endodontic instrument of claim 10 wherein the instrument comprises a fluted endodontic file having one or more flutes defining one or more corresponding cutting edges.
